(19) United States
(12) Patent Application Publication
(10) Pub. No.: US 2023/0110539 A1
(43) Pub. Date: Apr. 13, 2023

(54) METHODS AND APPARATUS FOR FABRICATING CURVED ELASTIC BANDS AND ARTICLES INCORPORATING CURVED ELASTIC BANDS

(71) Applicant: META PLATFORMS, INC., Menlo Park, CA (US)

(72) Inventor: Sarah HOIT, Seattle, WA (US)

(21) Appl. No.: 17/677,229

(22) Filed: Feb. 22, 2022

Related U.S. Application Data
(60) Provisional application No. 63/255,185, filed on Oct. 13, 2021.

(51) Int. Cl. D03D 3/00; G02B 27/01

(52) U.S. Cl. CPC D03D 3/005; G02B 27/0149; D10B 2501/042

(57) ABSTRACT

The present application is at least directed to a curved band having a plurality of warp yarns and a plurality of weft yarns. The curved band includes a first portion and a second portion. The first portion of the curved band has a first weaving density. The second portion of the curved band has a second weaving density that is less than the first weaving density. The curved band is configured to curve toward the second portion in response to contraction of the warp yarns.

### CROSS-REFERENCE TO RELATED APPLICATION

This application claims priority to U.S. Provisional Application No. 63/255,185, filed Oct. 13, 2021, which is incorporated by reference herein in its entirety.

### FIELD

The present application is directed to methods and apparatus for fabricating curved fabrics. More particularly, the present application is directed to methods and apparatus for fabricating curved elastic bands and articles incorporating curved elastic bands.

### BACKGROUND

Elastic fabrics for creating form-fitting articles of clothing are very popular. Sometimes, however, stretching a planar fabric over areas of high curvature can cause undue pressure across some areas of the curvature and/or excessively loose fit at others.

For some articles, fabric panels are cut into shapes and sewn together to minimize contours that exceed the ability of the fabric to stretch across the contour. However, the seams joining the panels can be uncomfortable. For example, head-mounted displays are typically secured to a user's head with elastic bands or webbing. Users typically find seams in the elastic bands to cause discomfort due to the skull being close to the surface of the skin so that any irregularity in the elastic band causes a point of skin compression. In addition, while the occipital lobe bone offers a convenient location for a elastic strap securing a head-mounted display, many users find the pressure of an elastic band across the occipital bone to be uncomfortable.

In view of the foregoing, there may be a need for an elastic band and articles incorporating elastic bands that curve or contour without the inconveniences associated with joining pieces of fabric together.

### SUMMARY

This summary is provided to introduce a selection of concepts in a simplified form that are further described below in the Detailed Description. This Summary is not intended to limit the scope of the claimed subject matter. The foregoing needs are met, to a great extent, by the present application described in more detail below.

In one aspect of the application, there is described a curved band having a plurality of warp yarns and a plurality of weft yarns. The curved band includes a first portion and a second portion. The first portion of the curved band has a first weaving density. The second portion of the curved band has a second weaving density that is less than the first weaving density. The curved band is configured to curve toward the second portion in response to contraction of the warp yarns.

In another aspect of the application, there is described an article. The article includes a curved band having a plurality of warp yarns and a plurality of weft yarns. The curved band includes a first portion and a second portion. The first portion of the curved band has a first weaving density. The second portion of the curved band has a second weaving density that is less than the first weaving density. The curved band is configured to curve toward the second portion in response to contraction of the warp yarns.

In yet another aspect of the application, there is described a method of fabricating a curved band. The curved band has a plurality of warp yarns and a plurality of weft yarns. The method includes the steps of weaving a first portion of the curved band at a first weaving density and weaving a second portion of the curved band at a second weaving density that is less than the first weaving density, The curved band is configured to curve toward the second portion in response to contraction of the warp yarns.

There has thus been outlined, rather broadly, certain embodiments of the invention in order that the detailed description thereof may be better understood, and in order that the present contribution to the art may be better appreciated.

### BRIEF DESCRIPTION OF THE DRAWINGS

In order to facilitate a more robust understanding of the application, reference is now made to the accompanying drawings, in which like elements are referenced with like numerals. These drawings should not be construed to limit the application and are intended only to be illustrative.

FIG. 1 illustrates a curved elastic band and a simplified diagram corresponding to a weaving pattern for the curved elastic band according to an aspect of the application.

FIG. 2 illustrates plain and different twill weaving structures during the weaving process and in a relaxed state according to an aspect of the application.

FIG. 3 illustrates the curved elastic band according to an aspect of the invention.

FIG. 4 illustrates the curved elastic band according to an aspect of the invention.

FIG. 5 illustrate an article incorporating the curved elastic band, such as for example a head-mounted display, according to an exemplary embodiment.

FIG. 6 illustrate an article incorporating the curved elastic band, such as for example a head-mounted display, according to an exemplary embodiment.

### DETAILED DESCRIPTION OF THE ILLUSTRATIVE EMBODIMENTS

A detailed description of the illustrative embodiment will be discussed in reference to various figures, embodiments, and aspects herein. Although this description provides detailed examples of possible implementations, it should be understood that the details are intended to be examples and thus do not limit the scope of the application.

Reference in this specification to “one embodiment,” “an embodiment,” “one or more embodiments,” “an aspect” or the like means that a particular feature, structure, or characteristic described in connection with the embodiment is included in at least one embodiment of the disclosure. Moreover, the term “embodiment” in various places in the specification is not necessarily referring to the same embodiment. That is, various features are described which may be exhibited by some embodiments and not by the other. While the object indicated in aspects of the application may reference a garment in certain exemplary embodiments, the scope of the present application is not limited to this specific exemplary embodiment.

Generally, the present application is related to a curved band or curved fabric, methods of fabricating the curved band, and articles incorporating the curved band. In some examples, the curved band is described as elastic. However, the curved band need not be elastic and may be inelastic. The present application describes weaving structures or zones to generate curves in the woven band. In an embodiment, the article incorporating the curved band is a head-mounted display and the curved band facilitates securing the head-mounted display to the head of a user while avoiding one or more areas of the user's head that may be sensitive. Doing so allows the head-mounted display to be worn with increased user comfort.

One aspect to achieve the above-mentioned results includes weaving the curved band with a standard, straight, loom. In an exemplary embodiment, a loom such as a multi-harness loom or Jacquard loom for example, is instructed to weave a denser structure on an outside curve portion of the band and a less dense structure on an inside curve portion of the band. The loom is warped with an elastic or shrink yarn and a less dense structure in the inside curve portion of the band allows the weft yarns to be pulled closer together. More particularly, the loom is instructed to fabricate a woven band with a controlled curve, created directly through the weaving construction and with no added parts or materials.

In a particular example using elastomeric yarns, during the construction of elastic band, any suitable elastomeric yarns are kept under tension, which is released at the end of weaving. Examples of suitable elastomeric yarns include, SPANDEX™, LYCRA™, elastane, and other polyether-polyurea polymers, other yarns with high elasticity, and the like. Weaving the elastic band under tension allows the stretch yarns to contract to their relaxed state. The amount of tension applied to the warp fibers during weaving is typically less than about 50% total elongation for the warp fibers to facilitate elongation during use. By creating portions of denser and less dense weave patterns the contraction of the elastomeric yarns back to their relaxed state is varied. This not only changes the elongation properties of specific areas, but changes the shape of the overall elastic band. In this instance into a curve as described herein.

In another particular example, the yarns making up the warp yarns of the loom may include a shrink yarn. For example, some polymers such as polyester exhibit heat shrinkage property that can be exploited to shrink the warp fibers after weaving. Another example of yarn shrinkage includes wool and/or cotton-based yarns that shrink when agitated. As with the elastic band described herein, by instructing the loom to create portions of denser and less dense weave patterns the contraction of the yarns due to shrinkage is used to control a curvature in the woven band.

Particular aspects of the invention will be described in more detail below.

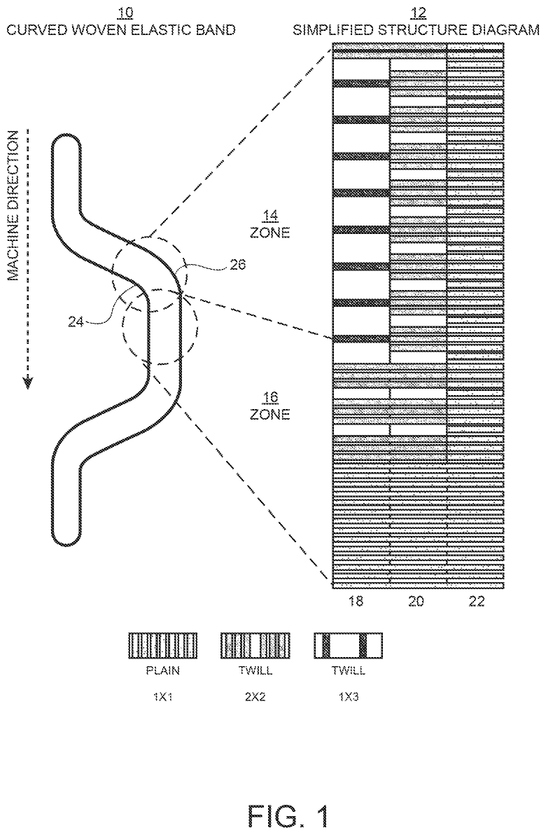

FIG. 1 illustrates a curved elastic band 10 and a simplified weaving diagram 12 corresponding to a weaving pattern for the curved elastic band 10 according to an aspect of the application. As shown in FIG. 1, the curved elastic band 10 transitions from a straight portion to a curved portion at zone 14. At zone 16, the curved elastic band 10 transition from a curved portion back to a straight portion.

In general, a column 18 in the simplified weaving diagram 12 provides instructions to the loom to generate a lower density weaving pattern in comparison to columns 20 and 22 and column 20 provides instructions to the loom to generate a higher density weaving pattern than column 18 and lower density weaving pattern than column 22. These columns of relatively lower and higher density generate the curvature in the curved elastic band 10. More particularly, the lowest density weaving pattern of column 18 generates an inside curvature 24 on the curved elastic band 10 and the highest density weaving pattern of column 22 generates an outside curvature 26 on the curved elastic band 10.

As described in more detail herein, the column 22 is woven in a 1×1 plain weave. That is, the warp yarns are woven over a first weft yarn and under a second weft yarn. Adjacent warp yarns are woven under the first weft yarn and under the second weft yarn. This alternating pattern repeats in a plain weave and generates a relative high density weave that contracts less when released from tension in comparison to a twill or satin weave pattern. The column 20 is also a plain weave at straight portions of the curved elastic band 10 and is a twill 2×2 weave pattern at curved portions of the curved elastic band 10. As described herein, in a twill 2×2 weaving pattern, the warp yarns pass over two weft yarns and under two weft yarns. In a twill 2×2 weaving pattern, adjacent warp yarns are generally offset by one weft yarn. The column 18 is also a plain weaving pattern at a straight portion of the curved elastic band 10 and a twill 2×2, 1×3 twill, additionally a 5 harness satin weave could be used at the curved portion of the curved elastic band 10. Alternatively, other satin weaving patterns could be used at the curved portion of the curved elastic band 10. For example, the column 18 may be a twill 1×3 or satin 1×4 weave at a most curved portion of the curved elastic band 10 and a twill 2×2 weave pattern at a less curved portion of the curved elastic band 10. In a 1×3 twill weaving pattern, the warp yarn passes over one weft yarn and under three weft yarns. Typically, the weave is offset one weft yarn and each adjacent warp yarn. However, the weave can be made less dense by offsetting less. For example, the weave may be the same for two three or more warp yarns in a row and then offset.

The curved elastic band 10 has a length and a width. In various examples, the columns 18-22 may include any suitable portion of the width of the curved elastic band 10. In the particular example shown, each of columns 18-22 occupy about ⅓ of the width of the curved elastic band 10. However, in other examples, each of the columns 18-22 may occupy from about 10% (width to width) to about 90% (width to width) of the width of the curved elastic band 10. In this regard, the column 20 is optional and, in some examples, the respective widths of the column 18 and 22 may combine to make the full width of the curved elastic band 10.

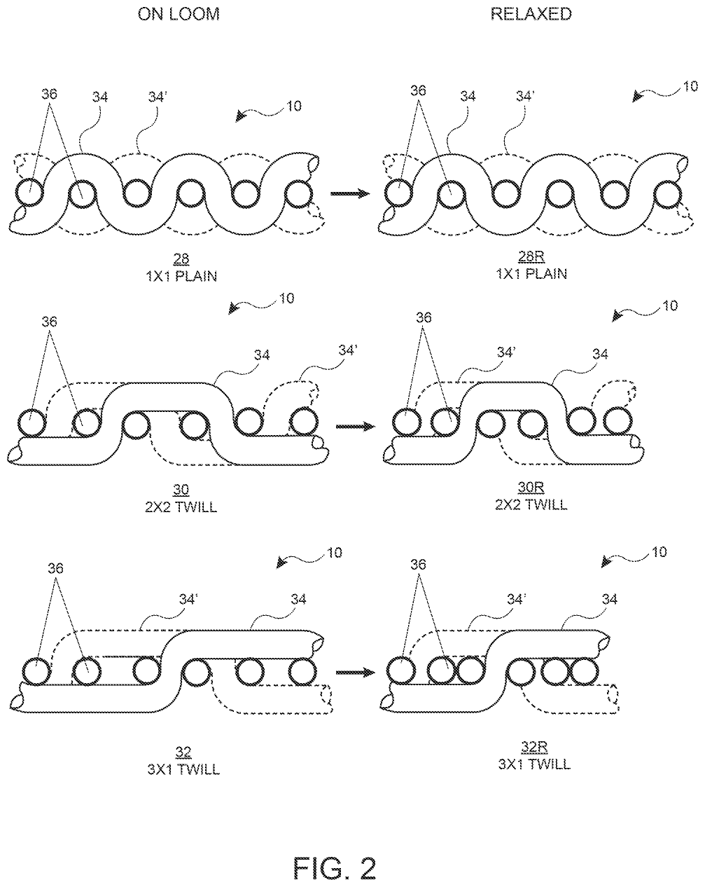

FIG. 2 illustrates a plain 28, 2×2 twill 30, and 1×3 twill 32 weaving structures during the weaving process and in a relaxed (28_{R}, 30_{R}, and 32_{R} respectively) state according to an aspect of the application. As shown in FIG. 2, in the plain 28 1×1 weaving structure, a warp yarn 34 passes over and under a series of weft yarns 36. As is generally understood in a 1×1 plain weaving pattern, each adjacent warp yarn 34 is offset from its neighbor and is shown as warp yarn 34′. As shown in FIG. 2, in the relaxed condition, the 1×1 plain weave 28_{R} is essentially the same length as the 1×1 plain weave 28 under tension on the loom. However, in other examples, the 1×1 plain weave 28_{R} may be shorter than the 1×1 plain weave 28 under tension on the loom. Also, depending on the elasticity of the warp yarns 34, the curved elastic band 10 may be operable to stretch substantially such as, for example, 50%, 100%, or greater than the curved elastic band 10 in the relaxed condition.

The 2×2 twill weave 30 is shown with the warp yarn 34 passing under two weft yarns 36 and over two weft yarns 36. As shown in FIG. 2, the adjacent warp yarn 36′ is shown offset one weft yarn 36. However, the adjacent warp yarn 36′ need not offset one weft yarn 36 and two or several warp yarns 36 may follow the same weaving pattern before offsetting. In the relaxed condition, the 2×2 twill weave 30_{R} shortens or contracts to a greater extent than the relaxed 1×1 plain weave 28_{R}. That is, because the warp yarns 34 pass over and under two yarns at a time, when the tension of the loom is released, there is no warp yarn 34 between the two weft yarns 36 and the warp yarns 34 pull the pair of weft yarns 36 closer together than the relaxed 1×1 plain weave 28_{R} would allow. Also, depending on the elasticity of the warp yarns 34, the curved elastic band 10 may be operable to stretch substantially such as, for example, 50%, 100%, or greater than the curved elastic band 10 in the relaxed condition.

The 3×1 twill weave 32 is shown with the warp yarn 34 passing under three weft yarns 36 and over one weft yarn 36. As shown in FIG. 2, the adjacent warp yarn 36′ is shown offset one weft yarn 36. However, the adjacent warp yarn 36′ need not offset one weft yarn 36 and two or several warp yarns 36 may follow the same weaving pattern before offsetting. In the relaxed condition, the 3×1 twill weave 32_{R} shortens or contracts to a greater extent than the either the relaxed 2×2 twill weave 30_{R} or the 1×1 plain weave 28_{R}. That is, because the warp yarns 34 pass over or under three yarns at a time, when the tension of the loom is released, there is no warp yarn 34 between these three weft yarns 36 and the warp yarns 34 pull the trio of weft yarns 36 closer together than the relaxed 2×2 twill weave 30_{R} or the 1×1 plain weave 28_{R} would allow. Also, depending on the elasticity of the warp yarns 34, the curved elastic band 10 may be operable to stretch substantially such as, for example, 50%, 100%, or greater than the curved elastic band 10 in the relaxed condition.

In the examples shown in FIG. 2, example is made of the use of elastic yarn. However, in other examples, the warp yarn 34 and/or weft yarn 36 may include inelastic or shrink yarn.

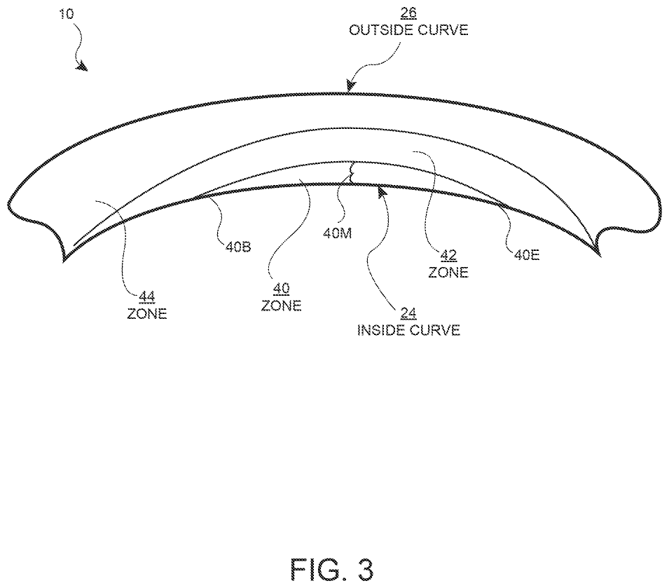

FIG. 3 illustrates the curved elastic band 10 according to an aspect of the invention. As shown in FIG. 3, a zone 40 is disposed proximal to the inside curve 24 of the curved elastic band 10. The weave pattern of the zone 40 increases gradually from one or a few warp yarns at a beginning 40B of the zone 40 until achieving a widest portion at a middle 40_{M} portion and then gradually tapers back down to one or a few warp yarns at an end 40_{E} of the zone 40. It is an advantage of the gradual taper of the zone 40 that the curved elastic band 10 may curve gradually, reduce pleating, and/or lay flatter in comparison to weaving patterns that do not taper.

Similar to other examples described herein, the weave pattern proximal to the inside curve 24 is relatively less densely woven in comparison to weave patterns disposed proximal to the outside curve 26. Importantly, the weave pattern of a zone 44 disposed proximal to the outside curve 26 need not be the plain weave 28 but may be a looser weave such as, for example, the 2×2 twill weave 30 or the 1×3 twill weave 32 as long as the weave pattern at the zone 40 is relatively less dense. For example, if the zone 44 includes the 1×3 twill weave 32, the zone 40 may include a 4, 5, or greater harness satin weave.

Optionally, the curved elastic band 10 may include a transition zone disposed between the zone 40 and 44 such as a zone 42. If included, the zone 42 may include a weave pattern that has a greater density than the zone 40 and less than zone 44.

The curved elastic band 10 has a length and a width. In various examples, the zones 40-44 may include any suitable portion of the width of the curved elastic band 10. In the particular example shown, each of the zones 40-44 occupy about ⅓ of the width of the curved elastic band 10. However, in other examples, each of the zones 40-44 may occupy from about 10% (width to width) to about 90% (width to width) of the width of the curved elastic band 10.

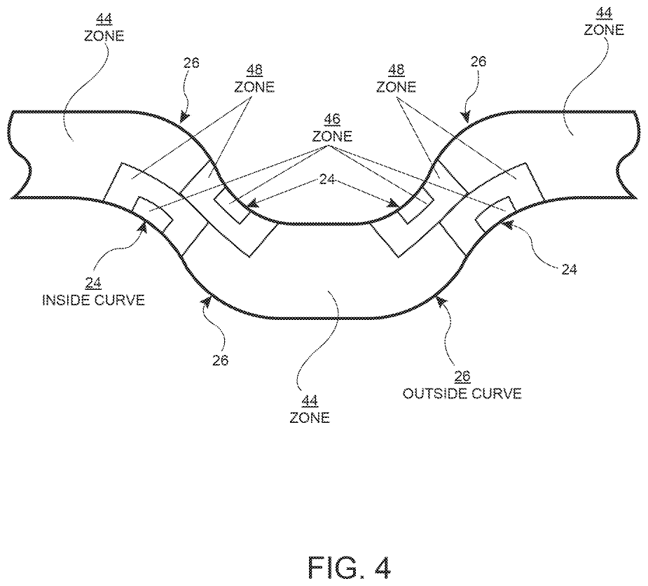

FIG. 4 illustrates the curved elastic band 10 according to an aspect of the invention. As shown in FIG. 4, a zone 46 is disposed proximal to the inside curve 24 of the curved elastic band 10. The weave pattern of the zone 40 does not taper and is a single width from beginning to end. It is an advantage of the abrupt transition to the less dense weave pattern of the zone 46 that the curve can be achieved with a smaller radius in comparison to a gradual taper of the zone 40 shown in FIG. 3.

Similar to other examples described herein, the weave pattern proximal to the inside curve 24 is relatively less densely woven in comparison to weave patterns disposed proximal to the outside curve 26. Importantly, the weave pattern of a zone 44 disposed proximal to the outside curve 26 need not be the plain weave 28 but may be a looser weave such as, for example, the 2×2 twill weave 30 or the 1×3 twill weave 32 as long as the weave pattern at the zone 46 is relatively less dense. For example, if the zone 44 includes the 1×3 twill weave 32, the zone 46 may include a 4, 5, or greater harness satin weave.

Optionally, the curved elastic band 10 may include a transition zone disposed between the zone 46 and 44 such as a zone 48. If included, the zone 48 may include a weave pattern that has a greater density than the zone 46 and less than zone 44.

The curved elastic band 10 has a length and a width. In various examples, the zones 44-48 may include any suitable portion of the width of the curved elastic band 10. In the particular example shown, each of the zones 46-48 occupy about ¼ of the width of the curved elastic band 10 and zone 44 occupies about ½ of the width of the curved elastic band 10. However, in other examples, each of the zones 44-48 may occupy from about 10% (width to width) to about 90% (width to width) of the width of the curved elastic band 10.

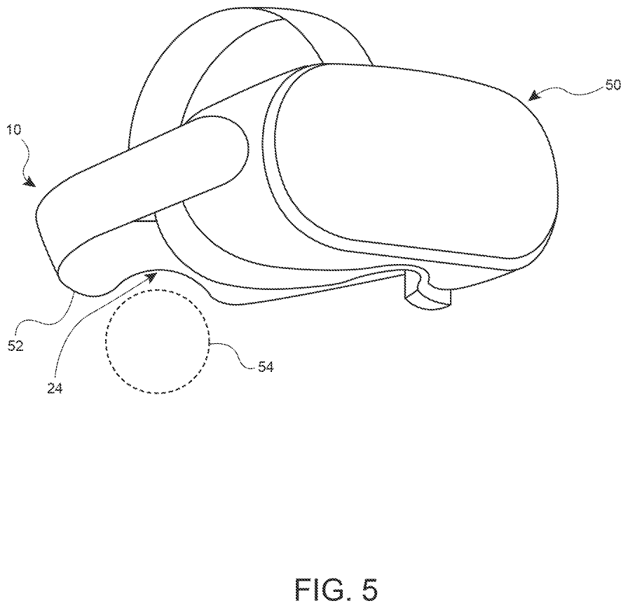

FIG. 5 illustrates an article 50 incorporating the curved elastic band 10, such as for example a head-mounted display, according to an exemplary embodiment. As shown in FIG. 5, the curved elastic band 10 is used to fabricate a head strap 52 to secure the article 50 to a head of a user. It is an advantage of the curved elastic band 10 that the curve can be configured to avoid an area 54 coinciding with an occipital lobe bone of the user. It is another advantage of the curved elastic band 10 that the inside curve 24 is proximal to the area 54 because the inside curve 24 is under relatively less tension than other portions of the curved elastic band 10. This lesser amount of tension is due to the warp yarns being more contracted at the inside curve 24 relative to other portions of the curved elastic band 10. As such, if the inside curve 24 does overlap the area 54, the reduced amount of tension from the inside curve 24 will reduce pressure and/or discomfort to the user. Of note, while the curve of the head strap 52 is shown to avoid the area 54 by curving around and over the area 54, in other examples, the head strap 52 may avoid the area 54 by curving around and under the area 54.

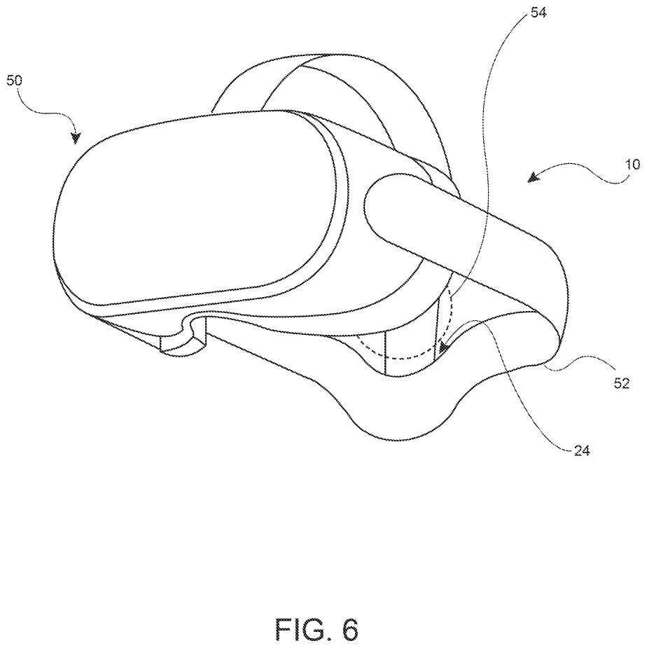

FIG. 6 illustrates the article 50 incorporating the curved elastic band 10, such as for example a head-mounted display, according to another exemplary embodiment. As shown in FIG. 6, the curved elastic band 10 is used to fabricate the head strap 52 to secure the article 50 to a head of a user. It is an advantage of the curved elastic band 10 that the curve can be configured to avoid the area 54 coinciding with an occipital lobe bone of the user. The article 50 of FIG. 6 differs from the article 50 of FIG. 5 in that the curved elastic band 10 is configured to curve under the area 54. Similar to the article 50 shown in FIG. 5, it is another advantage of the curved elastic band 10 that the inside curve 24 is proximal to the area 54 because the inside curve 24 is under relatively less tension than other portions of the curved elastic band 10. This lesser amount of tension is due to the warp yarns being more contracted at the inside curve 24 relative to other portions of the curved elastic band 10. As such, if the inside curve 24 does overlap the area 54, the reduced amount of tension from the inside curve 24 will reduce pressure and/or discomfort to the user.

While the methods, apparatus, and articles have been described in terms of what are presently considered to be specific aspects, the application need not be limited to the disclosed aspects. It is intended to cover various modifications and similar arrangements included within the spirit and scope of the claims, the scope of which should be accorded the broadest interpretation so as to encompass all such modifications and similar structures. The present disclosure includes any and all aspects of the following claims.

What is claimed is:

1. A curved band having a plurality of warp yarns and a plurality of weft yarns, the curved band comprising:
a first portion of the curved band having a first weaving density; and
a second portion of the curved band having a second weaving density that is less than the first weaving density, wherein the curved band is configured to curve toward the second portion in response to contraction of the warp yarns.

2. The curved band of claim 1, wherein the warp yarns are elastic.

3. The curved band of claim 1, further comprising a third portion disposed between the first portion and the second portion, the third portion having a third weaving density that is less than first weaving density and greater than the second weaving density.

4. The curved band of claim 1, wherein the first portion includes a 1×1 plain weave pattern and the second portion includes one or more of a 2×2 twill, 1×3 twill, and 1×4 satin weave pattern.

5. The curved band of claim 1, wherein the warp yarns are shrink yarns.

6. The curved band of claim 1, wherein the second portion gradually increases width until a predetermined width is achieved.

7. An article comprising:
a curved band including:
a plurality of warp yarns;
a plurality of weft yarns;
a first portion of the curved band having a first weaving density; and
a second portion of the curved band having a second weaving density that is less than the first weaving density, wherein the curved band is configured to curve toward the second portion in response to contraction of the warp yarns.

8. The article of claim 7, wherein the warp yarns are elastic.

9. The article of claim 7, further comprising a third portion disposed between the first portion and the second portion, the third portion having a third weaving density that is less than first weaving density and greater than the second weaving density.

10. The article of claim 7, wherein the first portion includes a 1×1 plain weave pattern and the second portion includes one or more of a 2×2 twill, 1×3 twill, and 1×4 satin weave pattern.

11. The article of claim 7, wherein the warp yarns are shrink yarns.

12. The article of claim 7, wherein the second portion gradually increases width until a predetermined width is achieved.

13. The article of claim 7, wherein the article is a head-mounted display and the curved band is a head strap to secure the head-mounted display to a head of a user.

14. The article of claim 13, wherein a curved portion of the curved band is configured to avoid an area coinciding with an occipital lobe bone of the user.

15. A method of fabricating a curved band, the curved band having a plurality of warp yarns and a plurality of weft yarns, the method comprising the steps:
weaving a first portion of the curved band at a first weaving density; and
weaving a second portion of the curved band at a second weaving density that is less than the first weaving density, wherein the curved band is configured to curve toward the second portion in response to contraction of the warp yarns.

16. The method of claim 15, wherein the warp yarns are elastic and the method includes the step of stretching the warp yarns during fabrication of the curved band.

17. The method of claim 15, further comprising the step of weaving a third portion disposed between the first portion and the second portion, the third portion having a third weaving density that is less than first weaving density and greater than the second weaving density.

18. The method of claim 15, wherein the first portion is woven with a weaving pattern that includes a 1×1 plain weave pattern and the second portion is woven with a weaving pattern that includes one or more of a 2×2 twill, 1×3 twill, and 1×4 satin weave pattern.

19. The method of claim 15, wherein the warp yarns are shrink yarns and the method includes the step of shrinking the shrink yarns after weaving.

20. The method of claim 15, further comprising the step of gradually increasing a width of the second portion until a predetermined width is achieved.
